(19) United States
(12) Patent Application Publication
(10) Pub. No.: US 2006/0192642 A1
(43) Pub. Date: Aug. 31, 2006

(54) Magnetic closure having alternating polarity connection

(76) Inventors: Marc L. Ruiz, Overland Park, KS (US); Lavie Golenberg, Farmington Hills, MI (US)

Correspondence Address: HARNESS, DICKEY & PIERCE, P.L.C., P.O. BOX 828, BLOOMFIELD HILLS, MI, 48303, US

(21) Appl. No.: 11/365,898

(22) Filed: Feb. 27, 2006

Related U.S. Application Data
(60) Provisional application No. 60/657,189, filed on Feb. 28, 2005.

(51) Int. Cl. H01H 9/00

(52) U.S. Cl. 335/207

(57) ABSTRACT

The object of the invention is to connect two or more of a material, device, or matter with the use of magnets that are connected to the said material, device, or matter that have an alternate polarity or charge down each side of the said material, device, or matter. With this method, the securing of material, device, or matter is made easier, quicker, and more effective then other method of securing material, device, or matter when using magnets.

### CROSS-REFERENCE TO RELATED APPLICATION

This application claims the benefit of U.S. Provisional Application No. 60/657,189, filed on Feb. 28, 2005. The disclosure of the above application is incorporated herein by reference.

### FIELD OF THE INVENTION

The present invention relates to a device for securing the closure of material, and in particular a set of magnetic buttons for use on a closure.

### BACKGROUND OF THE INVENTION

The use of magnetic fasteners as a closure mechanism is generally known in the art. For example, a magnetic button for articles of clothing and the like is disclosed in U.S. Pat. No. 4,736,494 which includes a female element having a magnetic core which cooperates with a metal, non-magnetic male element. Thus, the prior art teaches the use of a single magnetic core associated with the fastener elements.

However, the prior art poses a potential problem of misalignment between the material along the closure particularly with respect to clothing closures such as a shirt. Specifically, if the magnets are not correctly mated in line they will bunch up or connect to a non-corresponding or wrong magnet, thereby posing any number of problems. The prior art requires precise alignment of the magnets in one side of the material to the corresponding fastener element in the other side of the material. This is particularly difficult when mating and aligning magnets imbedded or covered magnets by the material, and therefore not visible. Accordingly, there is a need in the art to provide an aid for the user in accurately aligning, connecting, or securing a material out of view from the user.

### SUMMARY OF THE INVENTION

The present invention is directed to an article having two or more sets of magnets in series for connecting two pieces of material for easier and more effective alignment and the method of using such an article to fasten a closure. In this manner, the invention is intended to solve the problems, as discussed in the Background of Invention, of misaligning and/or connecting material by using alternating polarity on the adjacent sets of magnets. This combination of magnet polarities will afford proper alignment of the material once it is generally located. The present invention thus eliminates potential problems posed with the bunching up of and misalignment of the material, while facilitating the connecting of the material when the magnets are imbedded or secured inside the material out of view from the user. As such, it is an objective of the present invention to connect two or more materials with the use of magnets having an alternating polarity pattern on each side of the material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration showing one form of the present invention in the form of a shirt having a closure device including a series of magnet pairs with alternating polarity down each side;

FIG. 2 is a detail of one of the magnet pairs;

FIG. 3 is a cross-section through one of the magnet pairs;

FIG. 4 is a perspective illustration showing a closure having a series of magnet pairs in series with alternating polarity down each side; and

FIG. 5 is a plan view showing a closure having a series of magnet pairs in series with alternating polarity down each side.

Further illustrations of the present invention including photographs of a proto-type shirt are provided at attached pages A1-A6.

### DETAILED DESCRIPTION OF THE PREFERRED EMBODIMENTS

The following description of the preferred embodiment(s) is merely exemplary in nature and is in no way intended to limit the invention, its application, or uses.

The invention is directed to an article and method of using a series of magnet pairs that are aligned along a closure for connecting two (or more) materials. Each magnet pair has an alternating polarity orientation from that of the directly adjacent magnet pair. When arranged in series, each magnet in the magnet pair is more readily aligned with its corresponding magnet since it has the opposite charge of the two magnets surrounding it.

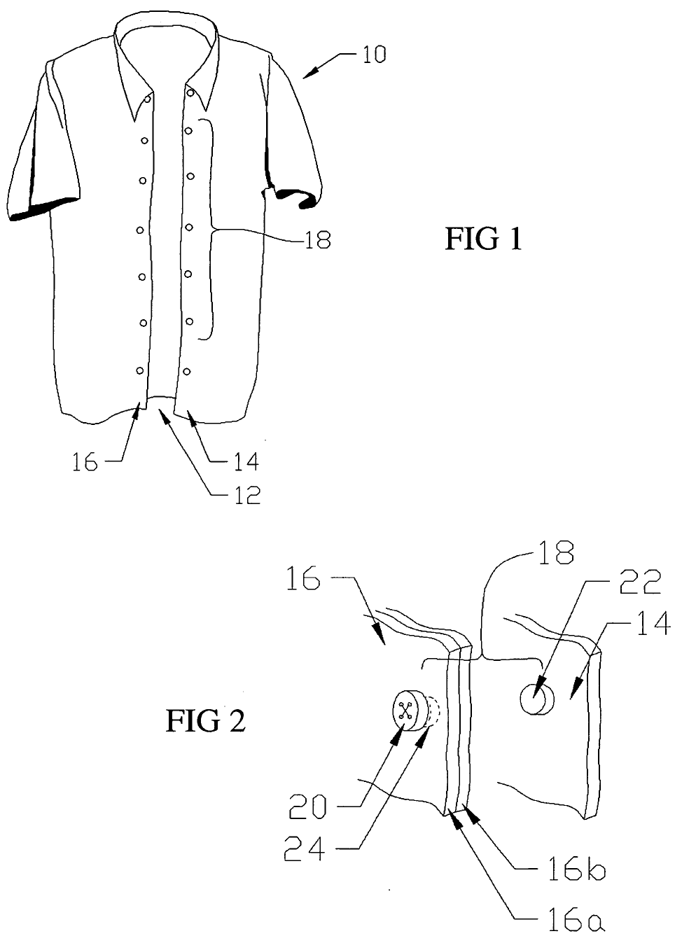

With reference now to the figures, the closure 12 includes first and second flaps 14, 16 of material. Specifically, as illustrated in FIG. 1, the closure 12 of the present invention is shown in the form of a shirt 10. A series of magnet pairs 18 are spaced along the closure 12 to function to hold the flaps 14, 16 together when positioned in an adjacent relationship. A decorative button 20 may be closely located with respect to each magnetic pair to provide the aesthetic appearance of a conventional button shirt.

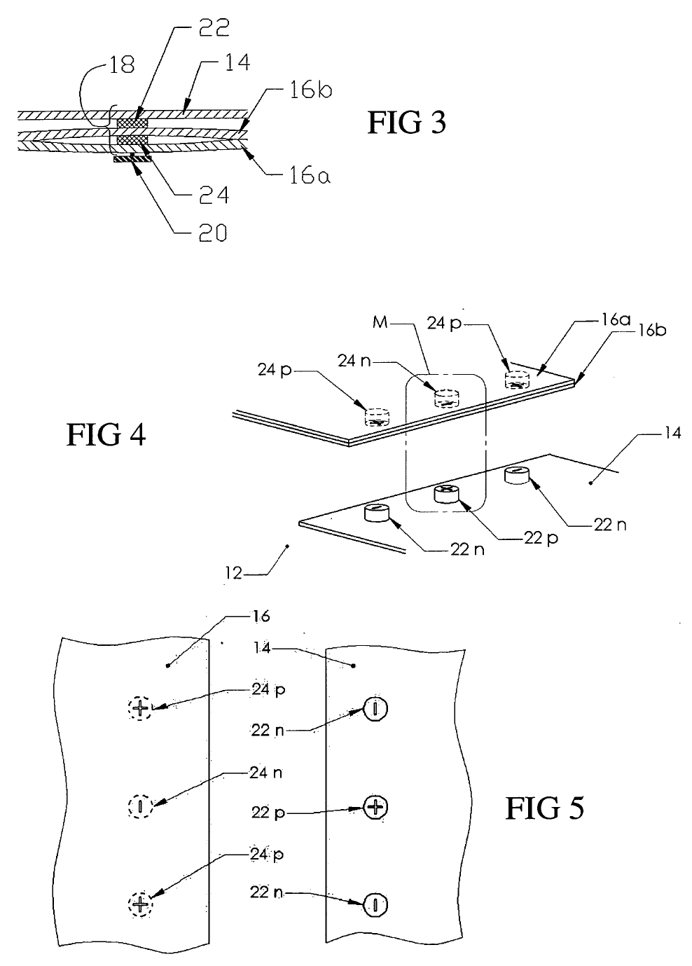

In accordance with the present invention, each of the magnetic pairs 18 includes a first magnetic element 22 associated with the first flap 14 and a second magnetic element 24 associated with the second flap 16. As presently preferred magnetic elements 22, 24 are generally disc-shaped magnetics, and more preferably a NdFeB disc magnetic coated in epoxy for rigidity. The size of each magnetic is dictated by its application and the materials associated with the closure. However, for use on articles of clothing, and specifically a shirt, it has been found that a magnetic having a diameter of approximately 3/8 of an inch and a thickness of approximately 1/16 of an inch is particularly well suited for first magnetic element 22 and that a magnetic having a diameter of approximately 3/8 of an inch and a thickness of approximately 1/8 of an inch is particularly well suited for second magnetic element 24. As best seen in FIG. 3, second magnetic element 24 is located within an interior pocket formed on flap 16 defined by first material portion 16A and second material portion 16B. First magnetic element 22 may likewise be located within the material portion of flap 14.

Turning now to FIGS. 4 and 5, the present invention contemplates the use of a series of magnetic pairs arranged in an alternating polarity orientation with respect to the directly adjacent magnetic pair. More specifically, it is illustrated in FIG. 4, the closure 12 is shown as having three sets of magnetic pairs including three first magnetic elements 22 disposed on first flap 14 and three corresponding second magnetic elements 24 disposed on second flap 16. The portion of the magnetic element 22 facing outwardly away from first flap 14 has polarity as indicated. To facilitate the understanding of the present invention, those first magnetic elements in which the outer face has a positive polarity are indicated as 22P and those first magnetic elements with the outer face having negative polarity are indicated as 22N. Similarly, those second magnetic elements 24 in which the polarity of the outer face is positive are indicated as 24P and the second magnetic elements in which the outer face have a negative polarity are indicated as 24N. From the illustrations, one skilled in the art will readily appreciate that the polarity of the middle magnetic pair indicated by the letter M has an opposite orientation from the adjacent magnetic pairs on either side thereof. Due to this alternating polarity, the second magnetic element 24N associated with the middle pair M is unable to provide a fastening closure with either of the first magnetic elements 22N associated with the adjacent magnetic pairs. Accordingly, the series of magnetic pairs 18 provide a self aligning closure which ensure that the proper magnetic pairs are aligned and connected. In this matter, the alternating polarity works to prevent the possibility for bunching or misaligning the magnetic pairs 18 and thus the closure 12 formed by flaps 14 and 16. While the most preferred embodiment contemplates alternating the polarity of each adjacent magnetic pair, one skilled in the art will recognize that the benefits of the present invention can be obtained by an alternating polarity pattern other than every other magnetic pair—for example every second, third, etc, magnetic pair.

What is claimed is:

1. In an article of the type having a first flap and a second flap defining a closure therebetween, said second flap positionable relative to said first flap to selectively open said closure, the improvement comprising a series of magnet pairs spaced along said closure, each magnet pair in said series of magnet pairs having a first magnetic element secured to said first flap and a second magnet element secured to said second flap, wherein at least one of said magnet pairs is arranged in an alternating polarity orientation with respect to an adjacent magnet pair.

2. The article of claim 1 wherein each magnet pair in said series of magnet pairs is arranged in an alternating polarity orientation with respect to said adjacent magnet pair

3. The article of claim 1 wherein said first flap comprises a first layer, a second layer and said first magnetic element is disposed between said first and second layers.

4. The article of claim 3 wherein at least one of said first magnetic element and second magnetic element is epoxy-coated.

5. The article of claim 1 wherein at least one of said first flap and said second flap has a decorative button thereon in close proximity to each of said series of magnet pairs.

6. The article of claim 1 wherein each of said magnet pairs comprise a first disc magnet secured to said first flap and a second disc magnet secured to said second flap.

7. An article of clothing comprising:
a first flap;
a second flap positionable relative to said first flap to selectively open a closure defined therebetween; and
a plurality of magnet pairs spaced along said closure, each of said plurality of magnet pairs having a first magnetic element secured to said first flap and a second magnet element secured to said second flap, wherein at least one of said series of magnet pairs is arranged in an alternating polarity orientation with respect to an adjacent magnet pair.

8. The article of clothing of claim 7 wherein each magnet pair in said series of magnet pairs is arranged in an alternating polarity orientation with respect to said adjacent magnet pair

9. The article of clothing of claim 7 wherein said first flap comprises a first layer, a second layer and a first magnetic element disposed between said first and second layers.

10. The article of clothing of claim 9 wherein at least one of said first magnetic element and said second magnetic element is epoxy-coated.

11. The article of clothing of claim 7 wherein at least one of said first flap and said second flap has a decorative button thereon in close proximity to each of said plurality of magnet pairs.

12. The article of clothing of claim 7 wherein each of said magnet pairs comprise a first disc magnet secured to said first flap and a second disc magnet secured to said second flap.
